(19) United States
(12) Patent Application Publication
(10) Pub. No.: US 2017/0045163 A1
(43) Pub. Date: Feb. 16, 2017

(54) COMPOSITE FITTING AND CONNECTION METHOD FOR MULTILAYER PIPES

(71) Applicants: Michael Alekseeveich POPOV, Balashiha (RU); Viktor Vladimirovich KRIKOTIN, Moscow (RU)

(72) Inventors: Michael Alekseeveich POPOV, Balashiha (RU); Viktor Vladimirovich KRIKOTIN, Moscow (RU)

(21) Appl. No.: 15/144,987

(22) Filed: May 3, 2016

Related U.S. Application Data
(60) Provisional application No. 62/204,509, filed on Aug. 13, 2015.

(51) Int. Cl. F16L 15/00; F16L 19/028

(52) U.S. Cl. CPC F16L 15/00; F16L 19/028

(57) ABSTRACT

The present invention is a method and apparatus for welding of multilayered pipe that reduces and avoids obstruction to the flow cross-section of the wielded pipe at connections and junctions. A reliable connection between multilayer pipes is made using a small assortment of inexpensive polymer elements.

### CROSS-REFERENCE TO RELATED APPLICATIONS

The present application claims priority to U.S. provisional application No. 62/204,509 filed on Aug. 13, 2015.

### BACKGROUND OF THE INVENTION

1. Field of the Invention

The present invention relates to connecting multilayered pipes using fittings.

2. Background Art

The present invention relates to connecting multilayered pipes using fittings. There are known multilayered pipes for systems including water supply, heating, conditioning, liquid and gas transportation comprised of barrier layer, outer and inner polymer layers. Typically, a barrier layer uses aluminum alloys, or copper, or polymers with low oxygen permeability, for example EVON (Ethylene-vinyl alcohol). Polymer layers use polyolefins: polyethylene (PE), polypropylene (PP), polybutene (PB). For the goals of the present invention, the most preferable are multilayered pipes with polymeric layers of thermoplastic polyolefins,

Multilayered pipes are connected by fittings. Well-known standard fittings are made from copper or polyphenylsulfone (PPSU), wherein the pipe is mechanically clamped between fitting elements. Such fittings greatly reduce the flow cross-section of the pipeline, are expensive to manufacture, and creating fitting production itself requires significant expenditures due to their large assortment

There are known fitting made from thermoplastic polymer where the fitting is welded to the outer and inner layers of the multilayer pipe. Examples of these fittings:

Connecting a multilayer pipe with such fitting is accomplished in one stage: the molten outer and inner surfaces of the end portion of the multilayer pipe and corresponding fitting surfaces are aligned and cooled under natural conditions until completely cool.

These fittings have a set of disadvantages:

1) In order to prevent the inner wall of the annular groove of such fittings from breaking during heating or connecting with the pipes requires making it with a sufficiently large thickness, which increases hydraulic resistance of the fitting.

2) When connecting the fitting to the pipe, excess molten weld is displaced from the welded seam into the inner surface of the pipes, lowering the flow cross-section of the pipeline. (Fig. A). The greater danger is the fact that the welding of the pipe and fitting is performed “blindly” and this disadvantage only manifests during pipeline operation.

3) For a comprehensive system of connections, a large assortment of these fitting is required. This requires large expenditures for creating their production equipment, increases their cost, and creates the need to have a large stockpile available for the producer and distributors.

### SUMMARY OF THE INVENTION

The aim of the present invention is to create a reliable connection between multilayer pipes with minimal reduction of the flow cross-section of the pipeline using a small assortment of inexpensive polymer elements.

The essence of the invention is that the connection of multilayer pipes is implemented in two stages using composite fitting made of standardized elements comprising a family of connectors and family of adapters during the first stage, the end portion of the multilayer pipe is welded to the adapter along the outer and inner pipe surfaces, wherein, for the duration of welding the adapter surfaces to the pipe and further connecting with melted pipe surfaces, a cylindrical instrument is installed at the flow opening of the adapter to prevent adapter deformation during heating and welding to the pipe, and block off the inner volume of the pipe from the excess molten weld leaking, from the welded connection. In the second stage, the cylindrical instrument is removed from the adapter, the adapter mounting surface is welded to the pipe and the connector mounting surface is melted and mated until the weld has completely cooled.

Standardized composite fitting elements are produced by pressurized injection molding or made from thermoplastic polyolefins, preferably from the group including: polyethylene (PE) and its copolymers, polyethylene of raised temperature resistance (PE-RT), polypropylene and its copolymers (PP), polybutene polybutene-1 and their copolymers (PB). Using the polyolefins as a material for composite fitting elements significantly reduces their cost compared to fitting made of copper or polyphenylsulfone.

### BRIEF DESCRIPTION OF THE DRAWINGS

The present invention will now be discussed in further detail below with reference to the accompanying figures in which:

FIG. 1 shows the pipe fitting.

FIG. 2 shows a variation of a family of connectors without adapters.

FIG. 3 shows an assortment of pipe fining adapters.

FIG. 4 shows a welding tool.

FIG. 5 shows a cylindrical instrument used during welding.

FIG. 6 shows the welding configuration.

FIG. 7 shows the composite fitting during the welding process.

FIG. 8 shows the composite fitting during the welding process.

FIG. 9 shows the composite fitting during the welding process.

FIG. 10 shows the composite fitting during the welding process.

### DETAILED DESCRIPTION OF THE PREFERRED EMBODIMENTS

Composite fining device shown on FIG. 1.

Each element of the connector (1) family with at least one throughway opening (2) for the flow of liquid or gas and at least two mounting surfaces (3) for connecting adapters (4) implemented in the form of cylindrical surfaces, or surfaces in the form of a truncated cone, or in the form of alternating cylindrical surfaces and surfaces in the form of a truncated cone, wherein, mounting surfaces of the connectors and adapters are standardized for at least two adjacent standard pipe sizes. For example, the connector family in the pipe size range from 16 to 110 mm are standardized in the following manner: 16-20 mm, 26-32 mm, 40-50 mm, 63-75 mm, 90-110 mm. Thus, adapter for pipes with diameters 16 mm and 20 mm have the same mounting surfaces and can be connected with any mounting surface by connector 16-20 mm.

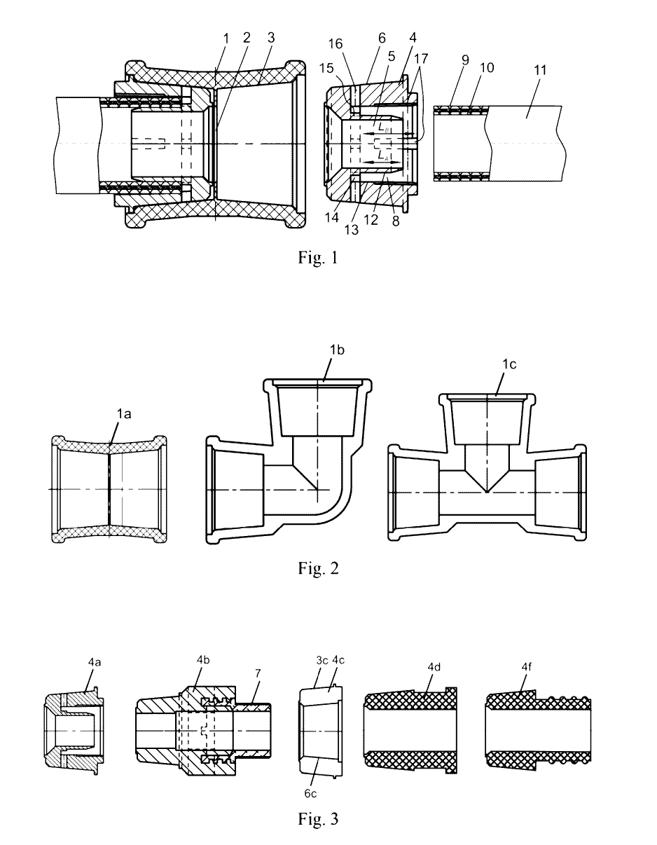

Connectors of this family can be implemented as sleeves (1a), corners (1b), T-couplings (1c), crosses, headers, valves, or other pipeline fittings for distribution, cut-off, regulation, and measuring, FIG. 2.

Standardizing mounting surfaces of connectors and adapters to adjacent standard sizes, and the composite character of the fitting allow a significant reduction in number of elements in the pipeline connection system. For example, using 30 elements (connectors and adapters) it is possible to create roughly 250 types of fittings. This allows a significant reduction in cost to create production, lower the amortization component of the cost, and lower distributor inventory costs.

Each element of the adapter (4) family includes an adapter throughway opening for flow of liquids or gas (5), an adapter mounting surface, corresponding to the connector mounting surface, implemented in the form of cylindrical surfaces, or surfaces in the form of a truncated cone, or in the form of alternating cylindrical surfaces and surfaces in the form of a truncated cone.

Adapters in this family can be made in the form of adapters for connectors with multilayer pipes (4a), adapters (4b) with threaded inserts (7), size adapters (4c) for transitioning from one standard connector (3c) mounting surface size to another standard adapter (6c) mounting surface size, adapters in the form of nipples (4d), adapters (4f) for press-connections and push-connections, as well as other adapters for connecting to other pipe types or other devices of the pipeline system, FIG. 3.

The most significant adapter family element is the adapter for connecting with multilayer pipes which include: annular groove (8) for connecting with outer (9) and inner (10) surfaces of the end portions of the multilayer pipe (11), whose inner wall (12) is bound by the adapter throughway opening, and the outer wall (13) is bound by the outer adapter surface, wherein, the adapter can be implemented with an inner wall length (L_{A}) smaller than, or equal to, or greater than the length of the outer wall (L_{B}).

The inner and outer surfaces of the annular groove of the adapter can be implemented in the form of cylindrical surfaces, with constant tubular cross-section along the length, or cross-section implemented in the form of alternating cylindrical surfaces and surfaces in the form of truncated cones.

To eliminate excess molten polymer, formed when connecting the adapter to the pipe, the adapter contains an annular cavity damper (14) which is a continuation of the annular groove and separated by a limiter (15) implemented in the form of a continuous collar, or at least one protrusion positioned on the inner or outer surfaces of the cavity damper, wherein, during filling of the cavity damper with molten material, any excess is extruded through drain hole (16) connecting the cavity damper with the outer adapter surface. In order to increase the tolerance of the adapter to allowances in pipe wall thickness, at least one coaxial adapter channel (17), with length less than or equal to the outer wall of the annular groove, can be placed on the outer wall of the annular groove. Channels, like in the cavity damper, eliminate excess molten material.

For melting welding surfaces of the connector and adapter, a standard welding apparatus for socket-welding polymer pipes with a set heater heads mounted on its welding mirror (18) can be used, FIG. 4.

Consisting of:

1) Heater head of the adapter (19) annular groove is a ferrule (20) mounted on flat base (21) or implemented with monolithic flat base, outer and inner surfaces which correspond to the inner and outer surfaces of the annular adapter groove;

2) Heater head of the pipe (22) surfaces consists of a housing (23) including: annular groove head (24) whose outer and inner surfaces correspond to the outer and inner surfaces of the annular adapter groove, cavity damper of head (25) with drainage opening (26) implemented as a continuation of the annular groove of the head and separated from it by the head (27) limiter implemented in the form of a continuous collar, or at least one protrusion positioned on the inner or outer surfaces of the cavity damper of the head;

3) Heater head of the connector (28) mounting surface with outer surface (29) corresponding to the connector mounting surface;

4) Heater head of the adapter (30) mounting surface with inner surface (31) corresponding to the adapter mounting surface.

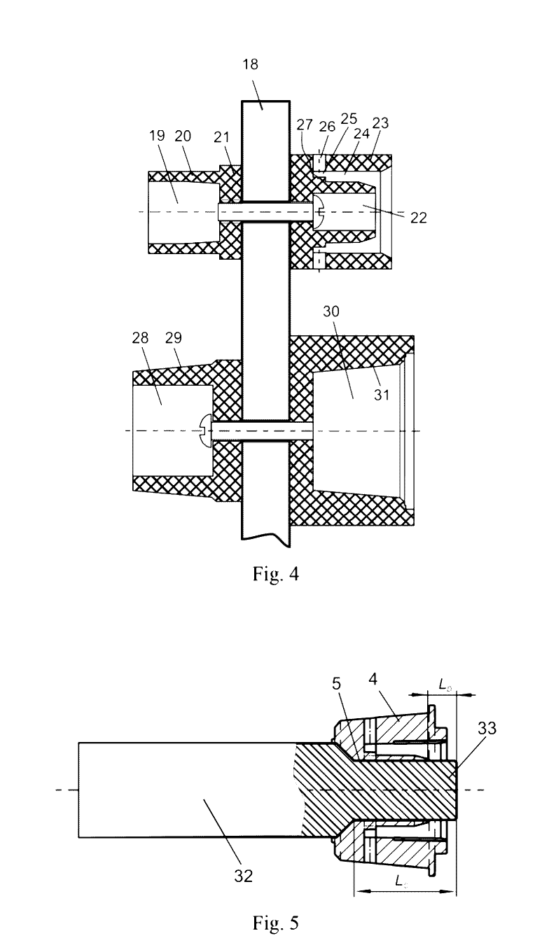

Heater heads can be implemented from ceramic, or metal with further application of non-stick coating to heads, for example, coating of polytetrafluoroethylene (PTFE). To prevent adapter deformation during welding and connecting to the pipe, a hollow or monolithic cylindrical instrument (33), FIG. 5, mounted on handle (32), made from metal or ceramic, or polymer with melting temperature greater than the adapter polymer, for example, polyphenylsulfone (PPSU) or polytetrafluoroethylene (PTFE).

Prior to the start of welding, cylindrical instrument is inserted into the throughway opening (5) of adapter (4), wherein the diameter of the cylindrical instrument corresponds to the inner diameter of the adapter throughway opening, with length LC selected such that the ends of the cylindrical instrument protrude from the adapter throughway opening by quantity LD comprising from 0.1 to 10 pipe wall thickness.

Using a cylindrical tool allows, without danger of breakdown during heating and welding to the pipe, the decrease of inner wall thickness of the annular adapter groove, thereby decreasing the hydraulic resistance of the adapter. Additionally, the protruding portion of the cylindrical instrument prevents the molten material leaking from the welding seam from decreasing the flow cross-section of the pipe by restricting the outflow through the gap between the cylindrical instrument and pipe.

### First Embodiment

The process of welding multilayer pipes using composite fitting is accomplished in the following manner:

1st Stage:

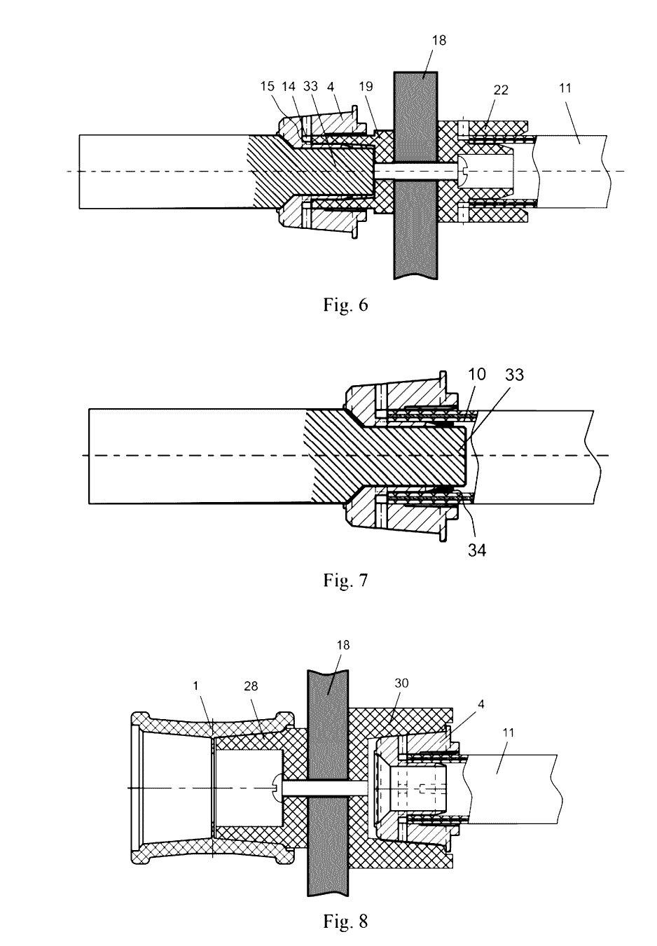

Adapter (4) with cylindrical instrument (33) inserted into throughway opening and the end portion of multilayer pipe (11) are inserted into the corresponding heater heads (19, 22) that are heated on the welding mirror (18) of welding apparatus, and held until connecting surfaces are melted. The cylindrical instrument does not allow deformation of the inner wall of the annular adapter groove, and by resting on the bottom of the welding heads limits the movement of heads into the adapter, protecting the limiter (15) and cavity damper (14), FIG. 6.

Next, the adapter, held by the cylindrical adapter, and pipe are removed from the heater heads and fitted together until the melted polymer cools under natural conditions, FIG. 7, wherein excess molten material (34) flowing out of the welding seam tills the gap between the cylindrical instrument (33) and inner wall (10) of multilayer pipe without changing the flow cross-section of the adapter.

2nd Stage:

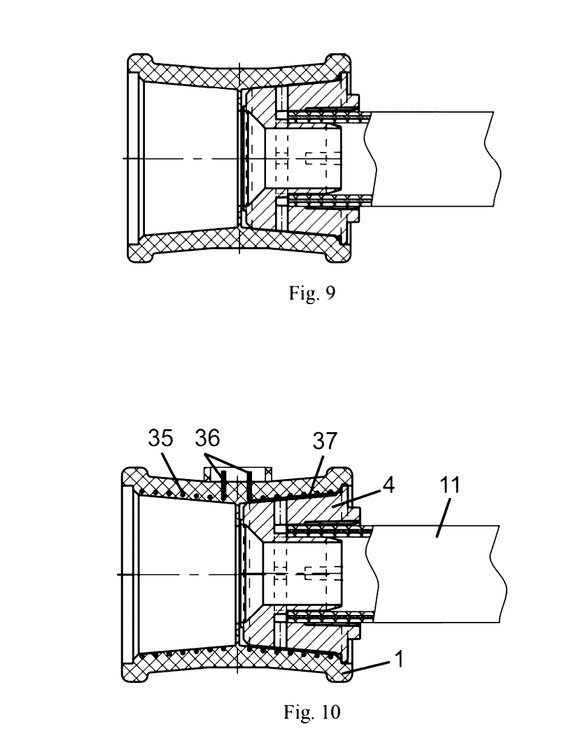

Thereafter, connector (1) and adapter (4) with pipe (11) welded to it insert mounting surfaces into corresponding heater heads (28,30) heated on the welding mirror (18) of the welding apparatus, FIG. 8, and then, after melting of the mounting surfaces the connector and pipe with adapter are fitted until the welds cool, FIG. 9.

### Second Embodiment

In the second embodiment, welding of the multilayer pipe and composite ^{.}fitting is also performed in two stages. Moreover, the first stage is completely analogous. However, during connection of the multilayer pipes in hard-to-reach places, or, for example, during installation of ceiling cooling system, use of the welding apparatus with heater heads at the second stage is quite difficult.

In this case, it is prudent to use the connector family or adapter family mounting surface which includes at least one heating element, implemented in the form of spirals or ribbons, from material with low electrical conductivity, or from material chosen from the group, including: nickel alloys, chrome alloys, ferroalloys; nichrome, fechral, carbon, graphite, silicon carbide, or in the form of an inductor.

The process of welding multilayer pipes using composite fitting in this embodiment is performed as follows:

1st Stage:

As in the first embodiment, implemented by welding end portion of the multilayer pipe along the inner and outer surfaces to the adapter and using cylindrical instrument to prevent deformation or breakdown of adapter parts during beating and welding, and limiting the spread of molten material flowing from the welded seam using a space between the outer surface of the cylindrical instrument and inner surface of the multilayer pipe.

2nd Stage:

During the second stage, FIG. 10, end portion of the multilayer pipe (11) with adapter (4) welded to it is inserted into connector (1) with built-in heating element (35), AC or DC power is supplied to terminals (36), connector mounting surface exposed to heating element melts, and its molten material melts the adapter mounting surface, forming a homogenous weld connection (37).

Technical Result:

Improved reliability of multilayer pipe connection, reduced fitting hydraulic resistance, lowered fitting cost, reduced overall quantity of elements for connecting multilayer pipes and as a result reduced cost of creating production, and reduced manufacturer and distributor stockpiles.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A composite fitting, comprising:
a. a connector family with multiple elements;
b. each element of the connector family having a throughway opening;
c. the at least one of the connector elements also having at least two mounting surfaces for connecting adapters;
d. each of the multiple elements made as an adapter;
e. wherein the adapter has an adapter mounting, surface that corresponds to a connecter mounting surface.

2. The composite fitting of claim 1, wherein the at least two mounting surfaces are shaped as a truncated cone, or shaped as alternating cylindrical surfaces and surfaces in a shape of a truncated cone.

3. The composite fitting of claim 1, wherein the at least two mounting surfaces for connecting adapters are standardized for at least two adjacent standard pipe sizes.

4. The composite fitting of claim 1, wherein the connector family is implemented as sleeves, corners, T-couplings, crosses, headers, valves, or other pipeline fittings for distribution, cut-off, regulation, and measuring.

5. The composite fitting of claim 1, wherein the adapter is made for connection with multilayer pipes, with threaded inserts, with size adapters, with nipple adapters, with press-connections, with push-connections, or other adapters for connecting to other pipe types or other devices of a pipeline system.

6. The composite fitting of claim 1, wherein the adapter made for connection with multilayer pipes includes an annular groove for connecting with an outer and an inner surface of end portions of the multilayer pipes, the inner surface is bound by the throughway opening and the outer surface is bound by an out adapter surface.

7. The composite fitting of claim 6, wherein the annular groove is implements as cylindrical surfaces with constant tubular cross-section along, its length or a cross-section implemented as alternating cylindrical surfaces and truncated cone surfaces.

8. The composite fitting of claim 6, wherein the annular groove has an annular cavity damper, which is a continuation of the annular groove, and is separated by a limiter implemented as a continuous collar or at least one protrusion positioned on an inner surface or an outer surface of the annular cavity damper, wherein, during filling of the annular cavity damper with molten material any excess molten material is extruded through a drain hole connecting the annular cavity damper and outer adapter surface.

9. A composite fitting welding apparatus, comprising:
a. a plurality of heater heads mounted on a welding mirror;
b. each of the plurality of heater heads of an adapter annular groove is ferrule mounted on a flat base or implemented with a monolithic flat base;
c. outer and inner surfaces correspond to inner and outer surfaces of an annular adapter groove;
d. each of the plurality of heater beads has a housing including an annular groove head with inner and outer surfaces that correspond to the inner and outer surfaces of the annular adapter groove;
e. a cavity damper with a drainage opening implemented as a continuation of the annular adapter groove of each of the plurality of heater heads;
f. the captive damper is separated from the annular adapter groove by a head limiter implemented as a continuous collar or at least one protrusion positioned on the inner or outer surfaces of the cavity damper.

10. The composite fitting welding apparatus of claim 9, wherein each of the plurality of heater heads includes a mounting surface with an outer surface corresponding to a connector mounting surface.

11. The composite fitting welding apparatus of claim 9, wherein each of the plurality of heater heads includes a mounting surface with an inner surface corresponding to an adapter mounting surface.

12. The composite fitting welding apparatus of claim 9, wherein each of the plurality of heater heads are made from ceramic, metal with further application of non-stick coating.

13. The composite fitting welding apparatus of claim 12, wherein the non-stick coating is made from polytetrafluoroethylene (PTFE).

14. The composite fitting welding apparatus of claim 9, including a hollow or monolithic cylindrical instrument to prevent deformation during welding or connection to a pipe, and wherein the hollow or monolithic cylindrical instrument has a length that is longer than an internal length of the annular adapter.

15. The composite fitting welding apparatus of claim 14, wherein each of the hollow or monolithic cylindrical instrument is made from ceramic, metal, or polymer with melting temperature greater than the adapter annular groove.

16. The composite fitting welding apparatus of claim 15, wherein the hollow or monolithic cylindrical instrument made from the polymer with melting temperature greater than the adapter annular groove where the polymer is polyphenysulfone (PPSU) or polytetrafluoroethylene (PTFE).

17. A pipe welding method, comprising the steps of:
a. heating heater heads on a welding mirror of a welding apparatus;
b. inserting a cylindrical instrument into a throughway opening of an adapter and inserting the adapter into one of the multiple heater heads;
c. the end portion of the multi layer pipe is inserted into one of multiple corresponding heater heads;
d. the adapter and the end portion of the multi layer pipe are held in the one of multiple corresponding heater heads until connecting surfaces of the adapter and the end portion of the multilayer pipe are melted forming a welding seam
e. the adapter and the end portion of the multilayer pipe are removed from the one of multiple corresponding heater heads and are fitted together until the melted section is cools under natural condition;
f. excess molten material flowing out of the welding seam fills a gap between the cylindrical instrument and an inner of the end portion of the multilayer pipe without changing a flow cross-section of the adapter.

18. The pipe welding method of claim 17, further including thereafter connector, the adapter seam welded to the multilayer pipe are inserted into the corresponding heater heads, heated on the welding mirror of the welding apparatus, and after melting of mounting surfaces the connector and the multilayer pipe with adapter are fitted until welds cool.

19. The pipe welding method of claim 17, further including thereafter connector, the adapter seam welded to the multilayer pipe are inserted into the connector, the connector having built-in heating elements powered by AC or DC power supplied at terminals, and after melting of mounting surf e connector and the multilayer pipe with adapter are fitted until welds cool.
